(19) United States
(12) Patent Application Publication
(10) Pub. No.: US 2025/0153191 A1
(43) Pub. Date: May 15, 2025

(54) FLOTATION RECOVERY RATE PREDICTION DEVICE, FLOTATION RECOVERY RATE PREDICTION METHOD, AND PROGRAM

(71) Applicants: SUMITOMO METAL MINING CO., LTD., Tokyo (JP); KYUSHU UNIVERSITY, NATIONAL UNIVERSITY CORPORATION, Fukuoka (JP)

(72) Inventors: Yoshiyuki TANAKA, Tokyo (JP); Tsuyoshi HIRAJIMA, Tokyo (JP); Yuji AOKI, Tokyo (JP); Hajime MIKI, Fukuoka (JP); Gde Pandhe Wisnu SUYANTARA, Fukuoka (JP)

(21) Appl. No.: 19/024,622

(22) Filed: Jan. 16, 2025

Related U.S. Application Data
(63) Continuation of application No. PCT/JP2022/030671, filed on Aug. 10, 2022.

(30) Foreign Application Priority Data
Jul. 20, 2022 (JP) 2022-115900
Jul. 20, 2022 (JP) 2022-115902

(51) Int. Cl. B03D 1/02

(52) U.S. Cl. CPC B03D 1/028

(57) ABSTRACT

A flotation recovery rate prediction device predicts, in flotation that separates a separation target metal from ores in which a plurality of ores containing a plurality of minerals are mixed, a recovery rate of the separation target metal, and includes a processor; and a memory storing program instructions that cause the processor to receive a desired recovery rate of the separation target metal; acquire information indicating a relationship between a soluble metal ratio and a mineral content percentage and information indicating a mineral content percentage and a recovery rate of the separation target metal for each of the ores; calculate a mixing ratio of the ores for achieving the desired recovery rate, based on the information indicating the relationship and the information indicating the mineral content percentage and the recovery rate for each of the ores; and output information indicating the calculated mixing ratio of the ores.

### CROSS-REFERENCE TO RELATED APPLICATIONS

This application is a continuation application of International Application No. PCT/JP2022/030671 filed on Aug. 10, 2022, and designating the U.S., which is based upon and claims priority to Japanese Patent Application No. 2022-115900, filed on Jul. 20, 2022 and Japanese Patent Application No. 2022-115902, filed on Jul. 20, 2022, the entire contents of which are incorporated herein by reference.

### BACKGROUND

### 1. Technical Field

The present disclosure relates to a flotation recovery rate prediction device, a flotation recovery rate prediction method, and a program.

### 2. Description of the Related Art

In general, from a mine to a factory, various processes, such as mining, crushing, grinding, flotation, and beneficiation are included. As a method of optimizing these processes, for example, Patent Document 1 discloses a processing method for online monitoring and optimization of mining and mined material processing work.

There is a method of performing flotation for separating ores containing a separation target metal from the other ores by utilizing the fact that mined ores become hydrophilic or hydrophobic depending on set conditions. Specifically, water and a chemical agent are added to finely crushed ores, and a valuable metal is attached to the surface of a generated bubble to recover the separation target metal.

### Related Art Document

### Patent Document

Patent Document 1: Japanese Laid-Open Patent Application Publication No. 2020-066992

### SUMMARY

According to one embodiment of the present disclosure, a flotation recovery rate prediction device predicts, in flotation that separates a separation target metal from ores in which a plurality of ores containing a plurality of minerals are mixed, a recovery rate of the separation target metal, and includes a processor; and a memory storing program instructions that cause the processor to receive a desired recovery rate of the separation target metal; acquire information indicating a relationship between a soluble metal ratio and a mineral content percentage and information indicating a mineral content percentage and a recovery rate of the separation target metal for each of the ores; calculate a mixing ratio of the ores for achieving the desired recovery rate of the separation target metal, based on the information indicating the relationship between the soluble metal ratio and the mineral content percentage and the information indicating the mineral content percentage and the recovery rate of the separation target metal for each of the ores; and output information indicating the calculated mixing ratio of the ores.

### BRIEF DESCRIPTION OF THE DRAWINGS

FIG. 1 is a diagram illustrating an example of a functional configuration of a flotation recovery rate prediction device;

FIG. 2 is a graph indicating an example of information indicating a relationship between a soluble metal ratio and a mineral content percentage;

FIG. 3 is a flowchart illustrating an example of a flow of a flotation recovery rate prediction process;

FIG. 4 is a diagram for explaining mixing of ores according to a second embodiment of the present invention;

FIG. 5 is a chart indicating an example of a screen display according to the second embodiment of the present invention;

FIG. 6 is a diagram illustrating an example of a screen display according to a third embodiment of the present invention; and

FIG. 7 is a diagram illustrating an example of a hardware configuration of the flotation recovery rate prediction device.

### DETAILED DESCRIPTION

Proportions of minerals contained mined ores are different, and flotation conditions are required to be adjusted. In order to examine the appropriateness of the flotation conditions in actual operations, there is a demand for predicting the metal recovery rate. However, with the conventional techniques, certain mineral species in mined ores have compositions that make them difficult to float, it is difficult to accurately predict the metal recovery rate in flotation for ores containing a mixture of minerals.

The prediction accuracy of the metal recovery rate in flotation for ores in which multiple minerals are mixed can be improved.

In metal mines, ore is mined and then subjected to a beneficiation process to produce a concentrate in which a mineral containing a target metal is concentrated, and then the produced concentrate is shipped as a raw material to a smelting plant. Here, flotation is often employed as a production technique in the beneficiation step. In that case, the beneficiation step is classified into crushing, grinding, flotation, and dewatering. A result of the flotation is closely related to the profit of a mine, and thus it is an important work to predict the recovery rate of the target metal by linking the grade of ore obtained by mining, mineral information, and the like to the beneficiation step.

Beneficiation is a separation method utilizing a difference in wettability of surfaces of minerals, and an operation of stirring suspension of ores and a liquid while blowing a gas, such as air or nitrogen, into the suspension. At this time, agents, such as the grain size of the ore, the pH of the suspension, a collector to be added, a foaming agent, and other conditioning agents, are added. In general, as the hydrophobicity of the surface of the mineral increases, more bubbles adsorb to the surface and thus the mineral easily floats in the suspension. As the hydrophilicity of the surface of the mineral increases, the mineral does not float in the suspension easily.

The ore contains various minerals and is mined in various locations. Ores, mined in various locations and containing various minerals, are mixed and supplied to the beneficiation step, and thus the ratio of minerals contained in the ores supplied to the beneficiation step changes each time. Therefore, it is difficult to predict the recovery rate by the beneficiation process, the grade of the ore to be concentrated, and the like in accordance with these changes.

Therefore, in the embodiment of the present invention, an example of predicting the flotation recovery rate in consideration of a mining place, a type of ore, a mixing ratio, and the like will be described.

### First Embodiment

A first embodiment of the present invention will be described below with reference to the drawings.

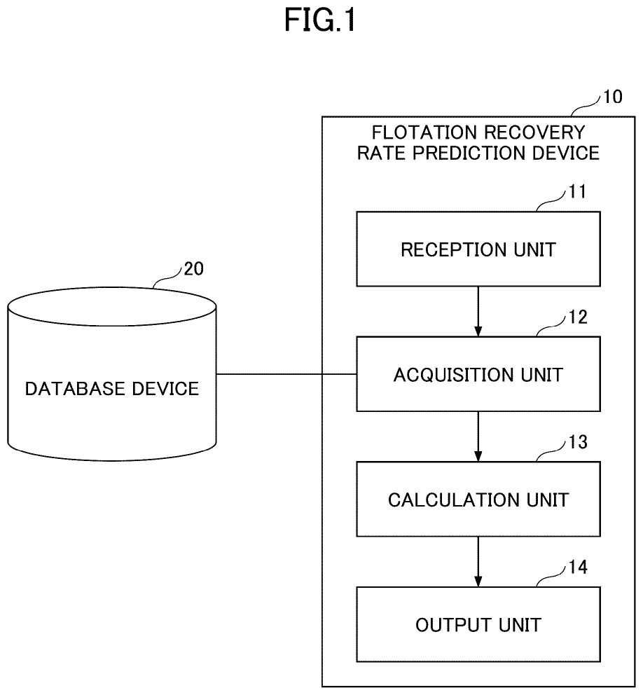

FIG. 1 is a diagram illustrating an example of a functional configuration of a flotation recovery rate prediction device. A flotation recovery rate prediction device 10 according to the present embodiment includes a reception unit 11, an acquisition unit 12, a calculation unit 13, and an output unit 14.

The reception unit 11 receives the particle size of the crushed ore, the pH value of the solution used in flotation, and the ratio of the target metal and the soluble metal ratio in the ore. For example, as indicated in Table 1, the reception unit 11 may receive a set of values of the ratio of soluble metal with respect to the ore to be subjected to the flotation process, the ratio of the target metal (the metal ratio) in the ore to be processed, the particle size of the crushed ore used for the flotation, and the pH of the solution during the flotation process, or may receive only some of the values indicated in Table 1 on the premise that a value in a predetermined range is used as an initial value. For example, in a case where the same ore is continuously processed or the like, when only the pH at the time of the process, such as crushing of the ore, changes, the reception unit 11 may receive only a change in the value of the particle size, the pH, or the like.

TABLE 1

| ITEM NAME | VALUE |
|---|---|
| SOLUBLE METAL RATIO | 0.008 |
| (%) | |
| METAL RATIO | 0.424 |
| (%) | |
| PARTICLE SIZE | 170 |
| (μm) | |
| pH | 8.51 |

The acquisition unit 12 acquires information indicating a relationship between the soluble metal ratio and the mineral content percentage from a database device 20. The soluble metal ratio is a ratio indicating the amount of the soluble metal to the total amount of the target metal in each mineral. The mineral content percentage is the ratio of each of the minerals in the ore. A specific example of the information indicating the relationship between the soluble metal ratio and the mineral content ratio will be described later.

Here, the database device 20 is communicably connected to the flotation recovery rate prediction device 10 via a communication line, a communication network, or the like. The database device 20 is a storage device that stores information indicating the relationship between the soluble metal ratio and the mineral content percentage.

The calculation unit 13 calculates the ratios of the multiple minerals and the recovery rate of the target metal obtained as a result of performing flotation for each of the minerals, using the soluble metal ratio received by the reception unit 11.

The output unit 14 outputs the ratios of the multiple minerals and the recovery rate of the target metal for each of the minerals, calculated by the calculation unit 13.

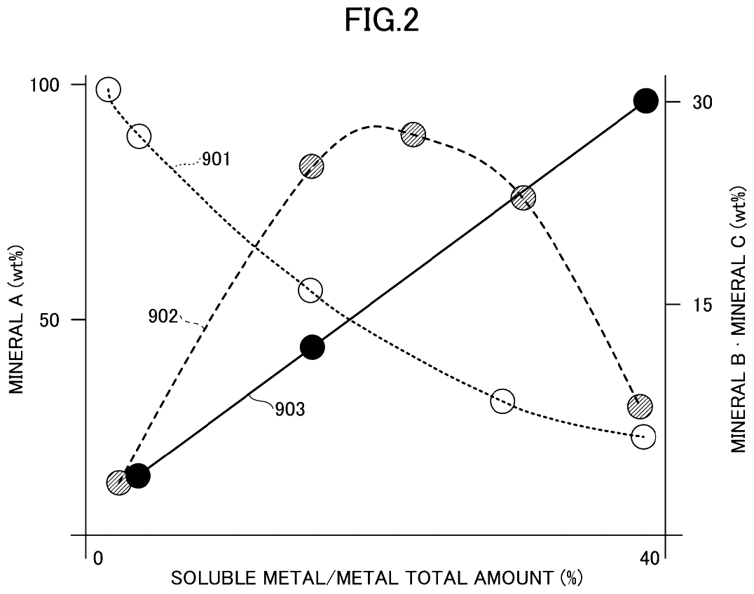

FIG. 2 is a graph indicating an example of the information indicating the relationship between the soluble metal ratio and the mineral content percentage. In FIG. 2, the horizontal axis represents the ratio of the amount of the soluble metal to the total amount of the separation target metal in the ore. The vertical axis in FIG. 2 represents the ratio of the mineral containing the target metal contained in the ore, for example, weight %. For example, a graph 901 indicates the content percentage of a mineral A, a graph 902 indicates the content percentage of a mineral B, and a graph 903 indicates the content percentage of a mineral C. According to FIG. 2, for example, when the ratio of the soluble metal amount is 40%, it is predicted that the content percentage of the mineral A is about 25%, the content percentage of the mineral B is about 10%, and the content percentage of the mineral C is about 30%.

The database device 20 stores the information by associating the soluble metal ratio with the mineral content percentage as a result of analyzing the mined ore.

The information indicating the relationship between the soluble metal ratio and the mineral content may be, for example, a database of a large amount of data obtained by collecting ores produced in various regions, or may be information obtained by a user selecting similar information by using the similar species of mineral as an index.

For example, when the separation target metal is copper (Cu), the copper grade and the ratio of soluble copper are different between primary sulfide ores, which are primary minerals being a deposit at the location where minerals constituting ores are formed, and secondary sulfide ores, which are ores that are oxidized by weathering near a surface layer and become sulfide ores again. Therefore, the content percentage of the mineral can be predicted by storing, in the database device 20 in advance, information indicating a relationship of the content percentage of each mineral with respect to the ratios of soluble copper in multiple ores.

Next, an operation of the flotation recovery rate prediction device 10 will be described with reference to the drawings. The flotation recovery rate prediction device 10 performs a flotation recovery rate prediction process by a user operation or the like.

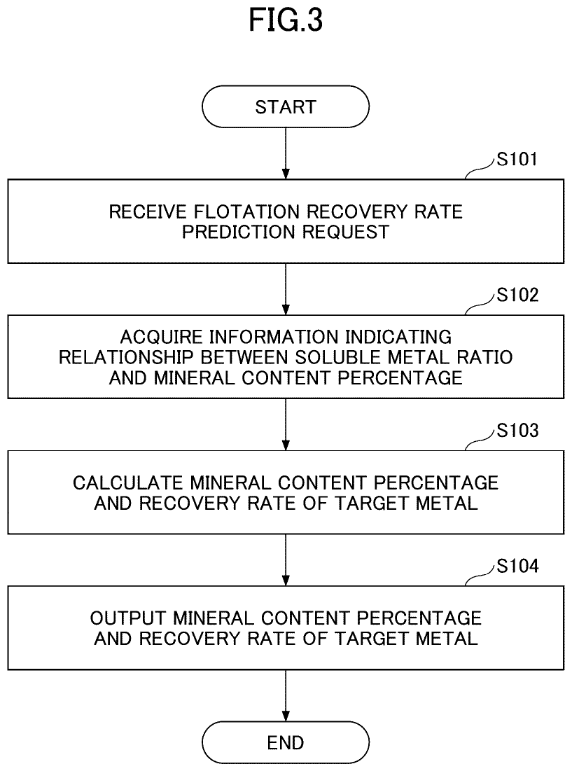

FIG. 3 is a flowchart illustrating an example of a flow of the flotation recovery rate prediction process. The reception unit 11 receives a flotation recovery rate prediction request (step S101). The acquisition unit 12 acquires the information indicating the relationship between the soluble metal ratio and the mineral content percentage (step S102).

The calculation unit 13 calculates the mineral content and the recovery rate of the target metal (step S103). Specifically, the calculation unit 13 may use a flotation rate equation of each mineral species containing the target metal for the prediction of the recovery rate. The flotation rate equation is expressed by the recovery rate of the target metal with respect to the flotation time under a predetermined condition, as indicated in Equation (1).

$$R = Rmax ( 1 - ekt ) \qquad ( 1 )$$

Here, R is the recovery rate, Rmax is the final recovery rate, k is a coefficient, and t is time.

The constant used in the flotation rate equation is preferably stored in advance in the database device 20 for each mineral species together with the information indicating the relationship between the soluble metal ratio and the mineral content percentage, and used as the predetermined coefficient. Additionally, the user may select and use similar information using the similar species of mineral as an index.

The output unit 14 outputs the mineral content percentage and the recovery rate of the target metal (step S104). For example, the output unit 14 may output the final recovery rate (for example, the recovery rate X % of the target metal α) and a list of the content percentages of minerals containing the separation target metal as indicated in Table 2.

TABLE 2

| | CONTENT PERCENTAGE |
|---|---|
| MINERAL | (%) |
| MINERAL A | 79.43 |
| MINERAL B | 5.98 |
| . . . | . . . |

The calculation unit 13 performs calculation based on the flotation rate equation, and thus the output unit 14 may output a list representing temporal changes in the content percentages of minerals and the recovery rate of the separation target metal as indicated in Table 3. For example, there is a mineral species that is difficult to be separated in flotation depending on the mineral species, and thus the user may be able to more easily understand whether a condition for performing flotation is appropriate by presenting the prediction result of the recovery rate for each mineral species.

TABLE 3

| | | | | RECOVERY RATE |
|---|---|---|---|---|
| | | | | (%) |
| | CONTENT PERCENTAGE (%) | | | TARGET METAL |
| TIME (min) | MINERAL A | MINERAL B | . . . | α |
| 0 | 0.000 | 0.000 | . . . | 0 |
| 1 | 18.364 | 0.002 | . . . | 16.019 |
| 3 | 40.090 | 0.004 | . . . | 28.166 |
| . . . | . . . | . . . | . . . | . . . |
| 30 | 60.630 | 0.020 | . . . | 72.021 |

Here, the separation target metal may be multiple metals. In this case, the calculation unit 13 calculates the recovery rate for each of the metals contained in the multiple separation target metals.

The separation target metal may be Cu or Mo. Additionally, the ore to be separated may be sulfide ore containing sulfur and copper.

The mineral contained in the ore may include any one of chalcopyrite, bornite, chalcocite, covellite, atacamite, or native Cu.

According to the flotation recovery rate prediction device 10 of the present embodiment, the recovery rate of the separation target metal can be predicted by calculation based on the information indicating the relationship between the soluble metal ratio and the mineral content percentage. Additionally, by outputting a list of the content percentages of minerals containing the separation target metal, the grade of the metal to be recovered can be predicted.

### Second Embodiment

A second embodiment will be described below with reference to the drawings. The second embodiment is different from the first embodiment in that an input of information indicating a mixing ratio of ores is received and the recovery rate of the target metal is predicted. Therefore, in the following description of the second embodiment, the differences from the first embodiment will be mainly described, the reference symbols substantially the same as those used in the description of the first embodiment are given to the functional configurations substantially the same as those of the first embodiment, and the description thereof will be omitted.

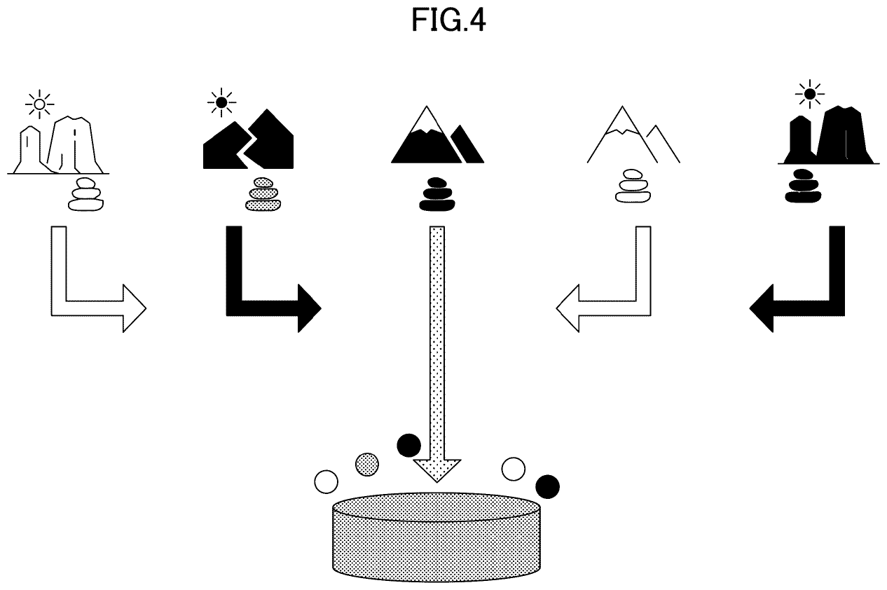

FIG. 4 is a diagram for explaining mixing of ores according to the second embodiment of the present invention. The ore contains various minerals and is mined in various locations. The ores mined at various locations and containing various minerals are mixed and supplied to the beneficiation step, the ratios of minerals contained in the ores supplied to the beneficiation step changes each time. Therefore, the flotation recovery rate prediction device 10 according to the present embodiment receives the input of the information indicating the mixing ratio of ores and predicts the recovery rate of the target metal. This can improve the prediction accuracy of the metal recovery rate in the case where ores containing various minerals are mixed.

The reception unit 11 according to the present embodiment receives the particle size of the crushed ore, the pH value of the solution used in flotation, and the ratio of the target metal and the soluble metal ratio in the ore, as with the reception unit 11 according to the first embodiment in step S101 of the flotation recovery rate prediction process illustrated in FIG. 3. In addition, the reception unit 11 according to the present embodiment further receives the information indicating the mixing ratio of the ores as an input as indicated in Table 4.

TABLE 4

| (input) | Sample A | Sample B | . . . | Sample X |
|---|---|---|---|---|
| MIXING RATIO (%) | 34.4 | 8.3 | . . . | α |
| SOLUBLE METAL RATIO | 0.008 | 0.12 | . . . | β |
| (%) | | | | |
| METAL RATIO (%) | 0.424 | 0.319 | . . . | γ |
| PARTICLE SIZE (μm) | 170 | 170 | . . . | δ |
| pH | 8.51 | 8.54 | . . . | ε |

Then, the calculation unit 13 according to the present embodiment calculates the recovery rate of the target metal by predicting the content percentages of minerals for each ore in step S103 of the flotation recovery rate prediction process illustrated in FIG. 3, and further calculates the recovery rate of the target metal based on the mixing ratio of the ores and the ratio of the amount of the soluble metal. Additionally, the calculation unit 13 may calculate the grade of the metal to be recovered based on the content percentages of minerals contained in the ore. As for the method of calculating the grade, the calculation unit 13 may calculate the grade, by the acquisition unit 12 acquiring information that has been stored in the database device 20 and that indicates the correlation between the content percentages of minerals and the grade of the metal.

The output unit 14 according to the present embodiment outputs the calculated recovery rate of the metal in step S104 of the flotation recovery rate prediction process illustrated in FIG. 3. Here, the output unit 14 may output the grade of the metal calculated by the calculation unit 13 as indicated in Table 5.

TABLE 5

| (output) | PREDICTION VALUE |
|---|---|
| TARGET METAL | 76.64 |
| RECOVERY RATE (%) | |
| METAL GRADE | 20.66 |

The calculation unit 13 performs calculation based on the flotation rate equation for each ore, the output unit 14 may output a list indicating the content percentages of minerals, the recovery rate and the grade of the separation target metal for each ore as indicated in Table 6. For example, by presenting the mineral species at the same time, the user can more easily understand the difference in the recovery rate, the grade, and the like among the ores. For example, when a mineral X is contained, the recovery rate may be deteriorated.

TABLE 6

| | | Sample A | Sample B | . . . | Sample X |
|---|---|---|---|---|---|
| TARGET METAL | | 82.68 | 53.74 | . . . | Z |
| RECOVERY RATE (%) | | | | | |
| GRADE | | 21.83 | 13.33 | . . . | H |
| MINERAL | MINERAL A | 94.86 | 53.74 | . . . | I |
| TYPE | MINERAL B | 1.75 | 13.33 | . . . | K |
| | . . . | . . . | . . . | . . . | . . . |
| | MINERAL X | 0 | 8.57 | . . . | λ |

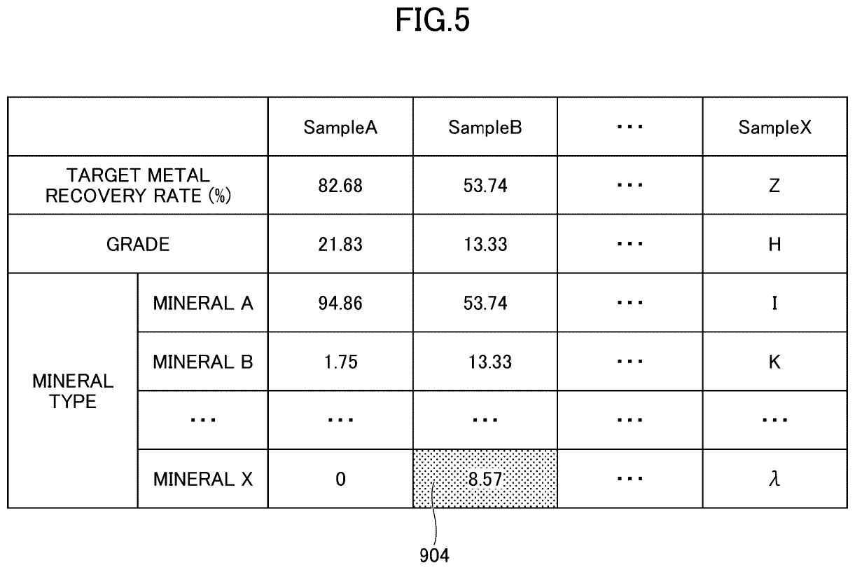

FIG. 5 is a chart indicating an example of a screen display according to the second embodiment of the present invention. The output unit 14 may display a list indicating the content percentages of minerals and the recovery rate and grade of the separation target metal for each ore on a screen, such as a display. Here, when a predetermined mineral has a content percentage greater than or equal to a predetermined threshold value, the mineral may be highlighted as in a frame 904. This facilitates the identification of minerals that greatly impact the recovery rate, and thus an ore having a large content percentage of the mineral can be identified.

According to the flotation recovery rate prediction device 10 of the present embodiment, the recovery rate of the target metal can be predicted by receiving the input of the information indicating the mixing ratio of ores. Additionally, the grade of the separation target metal can be predicted based on the information indicating the mixing ratio of the ores.

### Third Embodiment

A third embodiment will be described below with reference to the drawings. The third embodiment is different from the first embodiment in that an input designating a desired recovery rate is received and information indicating a mixing ratio of ores for obtaining the designated recovery rate is output. Therefore, in the following description of the third embodiment, the differences from the first embodiment will be mainly described, the reference symbols substantially the same as those used in the description of the first embodiment are given to the functional configurations substantially the same as those of the first embodiment, and the description thereof will be omitted.

The flotation recovery rate prediction device 10 according to the present embodiment receives the input designating the desired recovery rate and outputs the information indicating the mixing ratio of the ores for obtaining the designated recovery rate. With this, the recovery rate is controlled by adjusting the mixing ratio of the ores, thereby realizing a stable flotation environment.

The reception unit 11 according to the present embodiment receives, as an input, information indicating an expected value of the recovery rate of the target metal as illustrated in Table 7 in step S101 of the flotation recovery rate prediction process illustrated in FIG. 3. Furthermore, the reception unit 11 may receive, as an input, information indicating an expected value of the grade of metal.

TABLE 7

| (input) | EXPECTED VALUE |
|---|---|
| TARGET METAL | 75 |
| RECOVERY RATE (%) | |
| METAL GRADE | 20 |

Additionally, the database device 20 according to the present embodiment stores the information indicating the content percentages of minerals and the recovery rate and grade of the separation target metal for each ore, as illustrated in Table 6, in addition to the information indicating the relationship between the soluble metal ratio and the mineral content percentage according to the first embodiment. For example, in advance, the information may be generated by estimation based on the ratio of the soluble metal in each ore sample, or the information may be generated from chemical analysis, for example, from measurement results obtained by using a (polarization) microscope, an X-ray diffraction device, an electron probe micro analyzer (EPMA), or the like.

The acquisition unit 12 according to the present embodiment further acquires the information indicating the content percentages of minerals and the recovery rate and grade of the separation target metal for each ore in step S102 of the flotation recovery rate prediction process illustrated in FIG. 3.

The calculation unit 13 according to the present embodiment further calculates the mixing ratio of ores for achieving the designated recovery rate or grade based on the information indicating the content percentages of minerals and the recovery rate and grade of the separation target metal for each ore in step S103 of the flotation recovery rate prediction process illustrated in FIG. 3.

The output unit 14 according to the present embodiment outputs the calculated mixing ratio of ores as illustrated in Table 8 in step S104 of the flotation recovery rate prediction process illustrated in FIG. 3.

TABLE 8

| (output) | Sample A | Sample B | . . . | Sample X |
|---|---|---|---|---|
| MIXING RATIO (%) | 34.4 | 8.3 | . . . | α |
| SOLUBLE METAL RATIO | 0.008 | 0.12 | . . . | β |
| (%) | | | | |
| METAL RATIO (%) | 0.424 | 0.319 | . . . | γ |
| PARTICLE SIZE (μm) | 170 | 170 | . . . | δ |
| pH | 8.51 | 8.54 | . . . | ε |

Additionally, the reception unit 11 according to the present embodiment may receive, as an input, the information indicating multiple desired recovery rates of the target metal as illustrated in Table 9 in step S101 of the flotation recovery rate prediction process illustrated in FIG. 3.

TABLE 9

| | EXPECTED | EXPECTED | EXPECTED |
|---|---|---|---|
| (input) | VALUE 1 | VALUE 2 | VALUE 3 |
| TARGET METAL | 60 | 70 | 80 |
| RECOVERY RATE (%) | | | |

In this case, the calculation unit 13 according to the present embodiment calculates the mixing ratio of ores for a case where the designated recovery rate is achieved for each recovery rate based on the information indicating the content percentages of minerals and the recovery rate and the grade of the separation target metal for each ore in step S103 of the flotation recovery rate prediction process illustrated in FIG. 3.

The output unit 14 according to the present embodiment may output the mixing ratio of the ores calculated for each recovery rate as illustrated in Table 10 in step S104 of the flotation recovery rate prediction process illustrated in FIG. 3.

TABLE 10

| | | EXPECTED | EXPECTED | EXPECTED |
|---|---|---|---|---|
| | | VALUE 1 | VALUE 2 | VALUE 3 |
| TARGET METAL | | 60 | 70 | 80 |
| RECOVERY RATE (%) | | | | |
| MIXING | Sample A | α | 34.4 | δ |
| RATIO | Sample B | β | 8.3 | ε |

Additionally, as illustrated in Table 11, the output unit 14 may output the mixing ratio of ores for each mineral species together with the mixing ratio of ores calculated for each recovery rate.

TABLE 11

| | | EXPECTED | EXPECTED | EXPECTED | MINERAL | MINERAL |
|---|---|---|---|---|---|---|
| | | VALUE 1 | VALUE 2 | VALUE 3 | A | B |
| TARGET METAL | | 60 | 70 | 80 | | |
| RECOVERY RATE (%) | | | | | | |
| MIXING | Sample A | α | 34.4 | δ | 94.86 | 1.75 |
| RATIO | Sample B | β | 8.3 | ε | 53.74 | 13.33 |

This can provide information for the user to determine whether the recovery rate is easily adjusted.

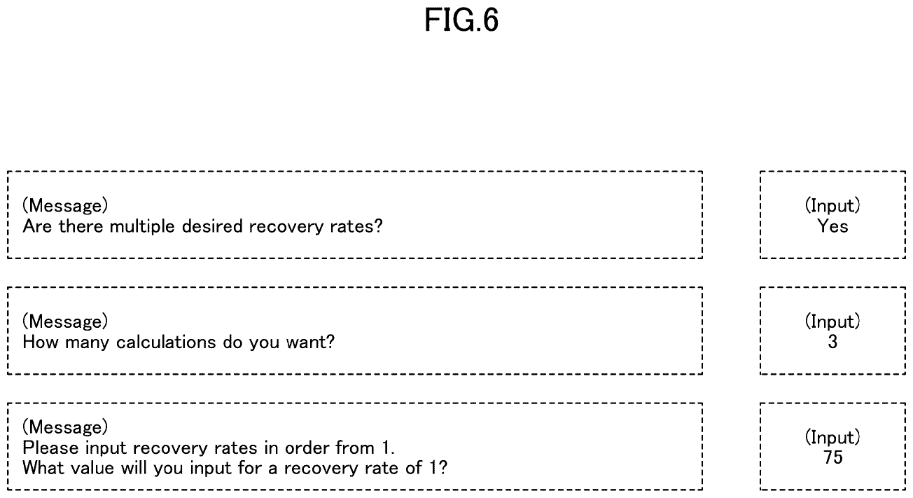

FIG. 6 is a diagram illustrating an example of a screen display according to the third embodiment of the present invention. As illustrated in FIG. 6, the reception unit 11 may receive the information indicating multiple expected values of the recovery rate of the target metal by receiving an input operation in an interactive form from the user in accordance with the screen display.

### Hardware Configuration of Flotation Recovery Rate Prediction Device

Next, a hardware configuration of the flotation recovery rate prediction device 10 will be described.

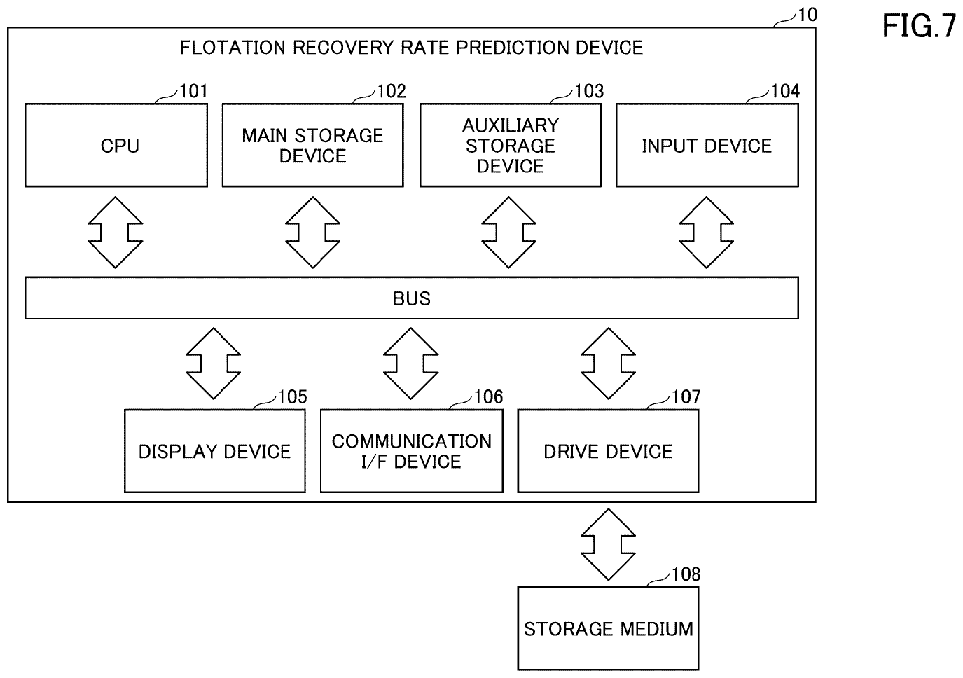

FIG. 7 is a diagram illustrating an example of the hardware configuration of the flotation recovery rate prediction device. The flotation recovery rate prediction device 10 is configured by a computer, and includes, for example, a central processing unit (CPU) 101, a main storage device 102, an auxiliary storage device 103, an input device 104, a display device 105, a communication interface device 106, and a drive device 107. These devices are connected to each other via a bus.

The CPU 101 is a main controller configured to control the operation of the flotation recovery rate prediction device 10, and realizes the various functions described above by reading and executing a program stored in the main storage device 102.

The main storage device 102 reads the program from the auxiliary storage device 103 and stores the program when the flotation recovery rate prediction device 10 is activated. The auxiliary storage device 103 stores the installed program, and also stores files, data, and the like necessary for various functions described below.

The input device 104 is a device for inputting various information, and is implemented by, for example, a keyboard, a pointing device, or the like. The display device 105 is for displaying various information, and is implemented by, for example, a display or the like. The communication interface device 106 includes a LAN card or the like, and is used for connection with another device or the like.

The program according to the present embodiment is at least a part of various programs for controlling the flotation recovery rate prediction device 10. The program is provided by, for example, distribution of a storage medium 108, downloading from a network, or the like. The storage medium 108 storing the program may be any of various types of storage media, such as a storage medium that optically, electrically, or magnetically records information, such as a CD-ROM, a flexible disk, or a magneto-optical disk, or a semiconductor memory that electrically records information, such as a ROM or a flash memory.

Additionally, when the storage medium 108 storing the program is set in the drive device 107, the program is installed from the storage medium 108 to the auxiliary storage device 103 via the drive device 107. The program downloaded from the network is installed in the auxiliary storage device 103 via the communication interface device 106.

Additionally, the flotation recovery rate prediction device 10 may be configured as a system in which multiple computers are communicably connected to each other, and may be configured such that the above-described processing units may be realized by being distributed to the multiple computers.

Additionally, the flotation recovery rate prediction device 10 may be a virtual machine operating on a cloud system.

While several embodiments have been described, these embodiments have been presented by way of example only, and are not intended to limit the scope of the invention. These new embodiments may be embodied in a variety of other forms, and various omissions, substitutions and changes can be made without departing from the spirit of the invention. These embodiments and modifications thereof are included in the scope and spirit of the invention, and are included in the invention described in the scope of the claims and equivalents thereof.

What is claimed is:

1. A flotation recovery rate prediction device for predicting, in flotation that separates a separation target metal from ores in which a plurality of ores containing a plurality of minerals are mixed, a recovery rate of the separation target metal, the flotation recovery rate prediction device comprising:
a processor; and
a memory storing program instructions that cause the processor to:
receive a desired recovery rate of the separation target metal;
acquire information indicating a relationship between a soluble metal ratio and a mineral content percentage and information indicating a mineral content percentage and a recovery rate of the separation target metal for each of the ores;
calculate a mixing ratio of the ores for achieving the desired recovery rate of the separation target metal, based on the information indicating the relationship between the soluble metal ratio and the mineral content percentage and the information indicating the mineral content percentage and the recovery rate of the separation target metal for each of the ores; and
output information indicating the calculated mixing ratio of the ores.

2. The flotation recovery rate prediction device as claimed in claim 1,
wherein the program instructions cause the processor to:
receive a desired grade of the separation target metal,
acquire information indicating the recovery rate and a grade of the separation target metal, and
calculate the mixing ratio of the ores for achieving the desired recovery rate of the separation target metal and the desired grade of the separation target metal based on the information indicating the relationship between the soluble metal ratio and the mineral content percentage and the information indicating the mineral content percentage and the recovery rate and grade of the separation target metal for each of the ores.

3. The flotation recovery rate prediction device as claimed in claim 1,
wherein the program instructions cause the processor to:
receive a plurality of desired recovery rates of the separation target metal,
respectively calculate mixing ratios of the ores for achieving recovery rates of the plurality of desired recovery rates of the separation target metal, and
output information indicating the mixing ratios of the ores calculated for the recovery rates of the plurality of desired recovery rates of the separation target metal.

4. The flotation recovery rate prediction device as claimed in claim 1, wherein the program instructions cause the processor to receive the desired recovery rate of the separation target metal by an input operation from a user according to a screen display.

5. The flotation recovery rate prediction device as claimed in claim 1, wherein the separation target metal is Cu or Mo.

6. The flotation recovery rate prediction device as claimed in claim 1, wherein the ores are sulfide ores containing sulfur and copper.

7. The flotation recovery rate prediction device as claimed in claim 1, wherein the minerals contained in the ores include any one of chalcopyrite, bornite, chalcocite, covellite, atacamite, or native copper.

8. A flotation recovery rate prediction method performed by a computer included in a flotation recovery rate prediction device for predicting, in flotation that separates a separation target metal from ores in which a plurality of ores containing a plurality of minerals are mixed, a recovery rate of the separation target metal, the flotation recovery rate prediction method comprising:
receiving a desired recovery rate of the separation target metal;
acquiring information indicating a relationship between a soluble metal ratio and a mineral content percentage and information indicating a mineral content percentage and a recovery rate of the separation target metal for each of the ores;
calculating a mixing ratio of the ores for achieving the desired recovery rate of the separation target metal, based on the information indicating the relationship between the soluble metal ratio and the mineral content percentage and the information indicating the mineral content percentage and the recovery rate of the separation target metal for each of the ores; and
outputting information indicating the calculated mixing ratio of the ores.

9. A non-transitory computer-readable recording medium having stored therein a program causing a computer included in a flotation recovery rate prediction device for predicting, in flotation that separates a separation target metal from ores in which a plurality of ores containing a plurality of minerals are mixed, a recovery rate of the separation target metal to execute:
receiving a desired recovery rate of the separation target metal;
acquiring information indicating a relationship between a soluble metal ratio and a mineral content percentage and information indicating a mineral content percentage and a recovery rate of the separation target metal for each of the ores;
calculating a mixing ratio of the ores for achieving the desired recovery rate of the separation target metal, based on the information indicating the relationship between the soluble metal ratio and the mineral content percentage and the information indicating the mineral content percentage and the recovery rate of the separation target metal for each of the ores; and
outputting information indicating the calculated mixing ratio of the ores.

10. A flotation recovery rate prediction device for predicting, in flotation that separates a separation target metal from an ore containing a plurality of minerals, a recovery rate of the separation target metal, the flotation recovery rate prediction device comprising:
a processor; and
a memory storing program instructions that cause the processor to:
receive a soluble metal ratio in the ore;
acquire information indicating a relationship between a soluble metal ratio and a mineral content percentage;
calculate the recovery rate of the separation target metal based on the information indicating the relationship between the soluble metal ratio and the mineral content percentage and the soluble metal ratio in the ore; and
output the calculated recovery rate of the separation target metal.

11. The flotation recovery prediction device as claimed in claim 10,
wherein the program instructions cause the processor to:
receive a particle size of the ore after crushing, a pH value of a solution used in the flotation, and a ratio of the target metal in the ore and a soluble metal ratio, and
calculate the recovery rate of the separation target metal based on the information indicating the relationship between the soluble metal ratio and the mineral content percentage, the particle size of the ore after crushing, the pH value of the solution used in the flotation, the ratio of the target metal in the ore, and the soluble metal ratio.

12. The flotation recovery prediction device as claimed in claim 10,
wherein the program instructions cause the processor to:
calculate a content percentage of a mineral contained in the ore based on the information indicating the relationship between the soluble metal ratio and the mineral content percentage, and
output the calculated recovery rate of the separation target metal and the calculated content percentage of the mineral contained in the ore.

13. The flotation recovery prediction device as claimed in claim 10,
wherein the program instructions cause the processor to
receives both information indicating a mixing ratio of a plurality of ores and a soluble metal ratio in each ore included in the plurality of ores, and
calculate the recovery rate of the separation target metal based on the information indicating the relationship between the soluble metal ratio and the mineral content percentage, the mixing ratio of the plurality of ores, and the soluble metal ratio in each ore included in the plurality of ores.

14. The flotation recovery prediction device as claimed in claim 10,
wherein the separation target metal is a plurality of metals, and
wherein the program instructions cause the processor to calculate a recovery rate for each metal included in the plurality of separation target metals.

15. The flotation recovery prediction device as claimed in claim 10, wherein the separation target metal is Cu or Mo.

16. The flotation recovery prediction device as claimed in claim 10, wherein the ore is a sulfide ore containing sulfur and copper.

17. The flotation recovery prediction device as claimed in claim 10, wherein the minerals contained in the ore include any one of chalcopyrite, bornite, chalcocite, covellite, atacamite, or native copper.

18. A flotation recovery rate prediction method performed by a computer included in a flotation recovery rate prediction device for predicting, in flotation that separates a separation target metal from an ore containing a plurality of minerals, a recovery rate of the separation target metal, the flotation recovery rate prediction method comprising:
receiving a soluble metal ratio in the ore;
acquiring information indicating a relationship between a soluble metal ratio and a mineral content percentage;
calculating the recovery rate of the separation target metal based on the information indicating the relationship between the soluble metal ratio and the mineral content percentage and the soluble metal ratio in the ore; and
outputting the calculated recovery rate of the separation target metal.

19. A non-transitory computer-readable recording medium having stored therein a program causing a computer included in a flotation recovery rate prediction device for predicting, in flotation that separates a separation target metal from an ore containing a plurality of minerals to execute:
receiving a soluble metal ratio in the ore;
acquiring information indicating a relationship between a soluble metal ratio and a mineral content percentage;
calculating the recovery rate of the separation target metal based on the information indicating the relationship between the soluble metal ratio and the mineral content percentage and the soluble metal ratio in the ore; and
outputting the calculated recovery rate of the separation target metal.
